(19) United States
(12) Patent Application Publication
(10) Pub. No.: US 2010/0133336 A1
(43) Pub. Date: Jun. 3, 2010

(54) System and Method for a Secure Transaction

(76) Inventor: Michael BAILEY, Bayport, NY (US)

Correspondence Address: MOTOROLA, INC., 1303 EAST ALGONQUIN ROAD, IL01/3RD, SCHAUMBURG, IL, 60196, US

(21) Appl. No.: 12/326,447

(22) Filed: Dec. 2, 2008

(51) Int. Cl. G06K 7/00

(52) U.S. Cl. 235/380

(57) ABSTRACT

A system and method is used to secure a transaction. The system comprises a data card and a payment receiving device. The data card stores confidential data related to the secure transaction. The payment receiving device receives the confidential data. A first credibility relating to the payment receiving device is verified. Upon the first credibility being verified, a second credibility relating to the data card is verified.

### FIELD OF THE INVENTION

The present invention relates generally to a system and method for authenticating a point of sale device. Specifically, the payment reader of the point of sale device is authenticated prior to confidential data being transmitted.

### BACKGROUND

In a retail environment, a computing device such as a cash register may be part of a point of sale (POS) arrangement for a transaction. The arrangement may enable an owner of a purchasing means (e.g., credit card, debit card, etc.) to provide secure data, thereby charging the owner for a purchase of an item. In the case of a credit card, the secure data may be a credit card number and/or a card verification number (CVN). In the case of a debit card, the secure data may be a debit card number and/or a personal identification number (PIN). The secure data may only be known by the owner of the purchasing means and also may be used as a means to indicate that it is the owner who is providing the information.

The computing device may include a payment reader such as a magnetic stripe reader (MSR) (e.g., for credit and debit cards), an integrated circuit card (ICC) (e.g., for contact and contactless smart cards),or near field communications devices. In the case where the MSR is used, there is no guarantee for the owner of a MSR card to be aware of an authentication of the MSR. That is, the use of the MSR includes only one communication from the card to the reader. No communication is made from the reader to the card prior to an attempt at transmitting account information. Without knowing if the MSR is authenticated, the secure transaction of providing confidential account information via the MSR may be compromised by an interceptor such as a rogue program that may reside in the computing device, that may be monitoring communications of the computing device, etc. In the case where the ICC is used, there is also no guarantee for the owner of the Smart Card and/or near field communications device of an authenticity of the ICC. Although a two way communication is capable, a rogue program may be present, thereby compromising the secure transaction. Thus, conventionally, only the buyer's credentials are verified for the secure transaction while the integrity of the payment receiving device is not verified.

### SUMMARY OF THE INVENTION

The present invention relates to a system and method for a secure transaction. The system comprises a data card and a payment receiving device. The data card stores confidential data related to the secure transaction. The payment receiving device receives the confidential data. A first credibility relating to the payment receiving device is verified. Upon the first credibility being verified, a second credibility relating to the data card is verified.

### BRIEF DESCRIPTION OF THE DRAWINGS

FIG. 1 shows a system comprising a mobile unit for receiving data related to a secure transaction from a data card according to an exemplary embodiment of the present invention.

FIG. 2 shows a first method of receiving data related to a secure transaction according to an exemplary embodiment of the present invention.

FIG. 3 shows a second method for receiving data related to a secure transaction according to an exemplary embodiment of the present invention.

### DETAILED DESCRIPTION

The exemplary embodiments of the present invention may be further understood with reference to the following description and the appended drawings, wherein like elements are referred to with the same reference numerals. The exemplary embodiments of the present invention describe a system and method for a secure transaction. According to the exemplary embodiments of the present invention, the system may include a payment receiving device and a payment data storage device. The payment receiving device may include a component that is capable of communicating (e.g., one-way or two-way transmission) with the payment data storage device. When the payment receiving device is properly authenticated to receive payment data, a secure transaction may take place. The payment receiving device, the payment data storage device, components of the devices, the payment data, and associate methods will be discussed in further detail below.

The following description illustrates that the payment receiving device may be a mobile unit (MU). The following description will therefore use the term MU to refer to the payment receiving device. In a first example, in a retail environment, the MU may be provided to a customer. The MU may provide the customer with various information relating to the retail environment and contents within the retail environment. The MU may also enable a “check-out” feature that enables the customer to scan objects that are to be purchased. Accordingly, the MU may receive secure data from the customer to complete the purchasing transaction. The payment receiving device may also be stationary such as a register. However, with respect to the exemplary embodiments of the present invention, the functionalities performed by the MU and the register may be substantially similar. Thus, stationary payment receiving devices will also be included in the description relating to the MU.

The following description also illustrates that the payment data storage device may be a data card. The following description will therefore use the term data card to refer to the payment data storage device. The data card may be, for example, a credit card or a debit card. In such an exemplary embodiment, the data card may include a magnetic strip that stores data relating to an account of an owner of the data card. The data card may also be, for example, a mobile device configured for near field communications (NFC). In such an exemplary embodiment, the data card may include an ICC to provide a means for either contact or contactless communication with the MU.

It should be noted that the following description in which the device is an MU is only exemplary. The exemplary embodiments of the present invention may generally apply to any computing device that is capable of performing the secure transaction. For example, the device may be a stationary computing device such as a register. Furthermore, it should be noted that the following description relates to a sales transaction. However, the exemplary embodiments of the present invention may generally apply to any device performing a secure operation for an exchange of confidential data.

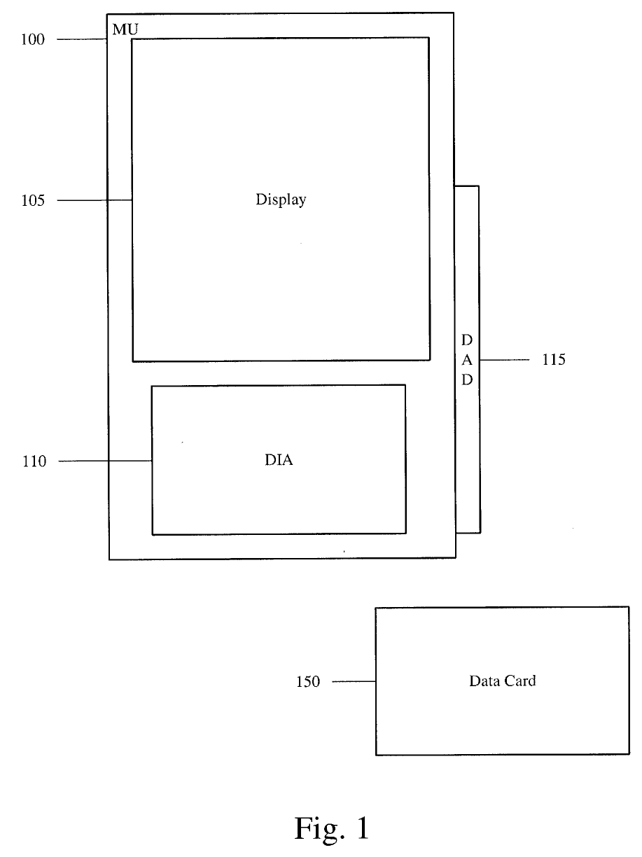

FIG. 1 shows a system comprising a mobile unit for receiving data related to a secure transaction from a data card according to an exemplary embodiment of the present invention. The MU 100 may be any electronic portable device such as a mobile computer, a personal digital assistant (PDA), a laptop, a scanner, an RFID reader, an image capturing device, a pager, a cellular phone, etc. The MU 100 may include a display 105, a data input arrangement (DIA) 110, and a data acquisition device (DAD) 115.

The display 105 may be a component of the MU 100 configured to show data to a user. The data may be, for example, related to a functionality or a program being executed on the MU 100. The display 105 may be, for example, a liquid crystal display (LCD). The display 105 may also be a touch screen display that is configured to receive tactile inputs from the user on an external surface of the display 105. The tactile inputs may be, for example, from a stylus or a finger of the user. According to the exemplary embodiments of the present invention, the display 105 may be used to show an indication of whether the MU 100 is an authenticated payment receiving device.

The DIA 110 may be configured to receive inputs from the user. The DIA 110 may be, for example, a keypad (e.g., numeric, alphanumeric, QWERTY, etc.). As discussed above, the display 105 may be an LCD with a touch screen. In this exemplary embodiment, the DIA 110 may be incorporated with the display 105. Thus, it should be noted that the DIA 110 being disposed as a separate unit from the display 105 is only exemplary. According to the exemplary embodiments of the present invention, the DIA 110 may be used for entering inputs related to the secure transaction. For example, the inputs may be an individual cost for each item of purchase, an identification for each item of purchase, a user name, etc.

The DAD 115 may be any component that is configured to receive data from a remote source. According to a first exemplary embodiment of the present invention, the DAD 115 may be an MSR. A user may swipe, for example, a credit/debit card that includes a magnetic strip that is encoded with data related to the card. The DAD 115 may receive the data. According to a second exemplary embodiment of the present invention, the DAD 115 may be a transceiver. A user may have an ICC that is capable of transmitting and/or receiving data related to the ICC. It should be noted that the DAD 115 may be other types such as a radio frequency identification (RFID) reader, a scanner, etc.

As discussed above, the data card 150 may be any item that stores data related to the user such as account information. According to the first exemplary embodiment of the present invention where the DAD 115 is an MSR, the data card 150 may be a credit or debit card. According to the second exemplary embodiment of the present invention where the DAD 115 is a transceiver, the data card 150 may be an ICC such as a smart card or an NFC device.

According to the exemplary embodiments of the present invention, the MU 100 may be configured to initially be proven to be an authenticated payment receiving device prior to an exchange of confidential information related to the user with the data card 150. By providing an initial check prior to the exchange, a user may be guaranteed that the confidential information to be provided will not be intercepted by, for example, a rogue program.

According to the first exemplary embodiment of the present invention, the MU 100 may be configured to deactivate the DAD 115 until an authentication check is performed or a command is received to activate the DAD 115. The MSR may be incapable of communicating with the data card 150 (e.g., credit card or debit card). Conventionally, the DAD 115 may be prepared to receive data upon the data card 150 being swiped through the DAD 115 to verify the buyer's credentials. However, the DAD 115 is incapable of communicating to the data card 150 which merely stores data encrypted in the magnetic strip. Thus, according to the first exemplary embodiment of the present invention, the MU 100 may prevent the data card 150 from providing the confidential information stored in the magnetic stripe. An administrator or an employee of the retail environment may be required to provide an authorized command to the MU 100 so that the DAD 115 becomes activated. This enables the user of the data card 150 to be aware that the MU 100 is an authenticated payment receiving device.

It should be noted that the authorized command may be used for a variety of scenarios depending on the MU 100. For example, the authorized command may be a key (e.g., electronic or physical) provided to the administrator or employee to place the MU 100 into a payment mode. An electronic key may be provided in a variety of manners (e.g., manually entered into the MU 100, received via a network connection, etc.). In the payment mode, the MU 100 may lock all functionalities except those used for processing the secure transaction. By locking out all other functionalities, the MU 100 may effectively prevent any other applications such as an interceptor from being able to receive any confidential information. Deactivating any connectivity functionalities (e.g., access to the Internet) may also prevent an interceptor from remotely receiving any of the confidential information. Until a time, for example, when the confidential information may not be intercepted or the confidential information is sufficiently encrypted, the MU 100 may remain in the payment mode. While in the payment mode, the MU 100 may be guaranteed as an authenticated payment receiving device. It should be noted that certain connections may remain active to verify the buyer's credentials. However, such connections may be predetermined as a secure channel that prevents interceptors.

According to the second exemplary embodiment of the present invention, the MU 100 may be configured to provide authentication confirmation from the DAD 115 to the data card 150. Specifically, the transceiver may forward a determination of authenticity to the ICC (e.g., smart card or NFC device). Conventionally, the DAD 115 may indicate that it is prepared to receive data from the data card 150. The data card 150 may respond by transmitting the confidential information to verify the buyer's credentials. According to the second exemplary embodiment of the present invention, the MU 100 may instead initially provide the indication of authenticity to the data card 150. The data card 150 may be configured to prevent any transmission of confidential information until reception of the indication of authenticity from the DAD 115. The determination for authenticity of the MU 100 may be performed in a substantially similar manner as discussed above with the first exemplary embodiment of the present invention.

When the data card 150 receives the indication of authenticity that provides that the MU 100 is an authenticated payment receiving device, the data card 150 may transmit the confidential information to the MU 100 via the DAD 115. Accordingly, when the data card 150 receives the indication of authenticity that provides that the MU 100 is not an authenticated payment receiving device, the data card 150 may terminate any communications channel between the data card 150 and the DAD 115. It should be noted that the data card 150 may terminate the communications channel for other reasons that indicate that the MU 100 is potentially not an authenticated payment receiving device. For example, the above example describes a direct indication of authenticity. The data card 150 may be configured to terminate the communications channel when a reply to an authentication query is not received within a predetermined amount of time. That is, if the MU 100 is functioning properly and receives the query, the indication of authenticity may be provided within a predetermined window of time. If such indication is not received, this may indicate to the data card 150 that the MU 100 may not be functioning properly or may not be authenticated.

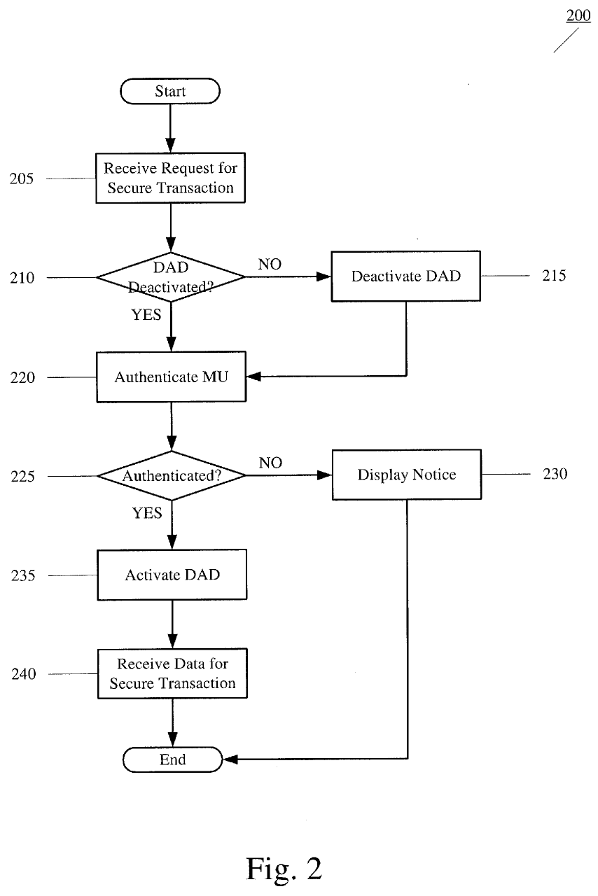

FIG. 2 shows a first method 200 of receiving data related to a secure transaction according to an exemplary embodiment of the present invention. The first method 200 will be described in relation to the first exemplary embodiment of the present invention where the DAD 115 is an MSR and the data card 150 is a credit or debit card with a magnetic strip storing confidential information. The first method 200 will be described with reference to the system 100 of FIG. 1.

In step 205, a request for a secure transaction is received by the MU 100. The MU 100 may perform a variety of functionalities. One of these functionalities may be a check-out functionality in which the user provides confidential information to verify the buyer's credentials. The request for the secure transaction may initialize certain functionalities related to the secure transaction. For example, a connection to a remote source may be established to verify the buyer's credentials.

In step 210, a determination is made whether the DAD 115 is deactivated. According to the exemplary embodiments of the present invention, the DAD 115 is intended to remain deactivated until such time the DAD 115 is authorized to become activated. As discussed above, such time refers to when the MU 100 has been determined to be an authenticated payment receiving device. If step 210 determines that the DAD 115 is activated, the method 200 proceeds to step 215 where the DAD 115 is deactivated.

Once it is determined that the DAD 115 is deactivated, the method 200 proceeds to step 220 where an authentication check is performed for the MU 100. As discussed above, the authentication check may involve receiving a key from an administrator or an employee of the retail facility that places the MU 100 in a payment mode. The payment mode may effectively make the MU 100 an authenticated payment receiving device.

In step 225, a determination is made whether the MU 100 is an authenticated payment receiving device. It may be possible that the key (when electronic) received from the administrator or the employee may become corrupted or altered by an interceptor. Thus, the key may not be valid and would not place the MU 100 in the payment mode. Accordingly, the MU 100 may not be an authenticated payment receiving device.

If step 225 determines that the MU 100 is not an authenticated payment receiving device, the method 200 proceeds to step 230 where a notice is shown on the display 105 indicating that the MU 100 is not authenticated. The notice may prevent a user from swiping the data card 150 through the DAD 115. However, even if the user ignores the notice and proceeds to swipe the data card 150, because the DAD 115 is deactivated, no confidential information is read from the magnetic strip of the data card 150. It should be noted that the notice being shown on the display 105 is only exemplary. Those skilled in the art will understand that a variety of alerts may be provided. For example, in another exemplary embodiment, a light emitting diode (LED) may shine one color (e.g., red) to indicate that the DAD 115 is still deactivated.

If step 225 determines that the MU 100 is an authenticated payment receiving device, the method 200 proceeds to step 235 where the DAD 115 is activated. Once activated, the user may swipe the data card 150 through the DAD 115. In step 240, the data for the secure transaction (e.g., account information, PIN, etc.) is received to complete the secure transaction. It should be noted that the activation of the DAD 115 (step 235) may entail a notification. In a first example, the notification may be shown on the display 105 of the MU 100. In another example, the LED which shines red to indicate that the DAD 115 is deactivated may shine green to indicate that the DAD 115 is activated and prepared to receive the data from the data card 150.

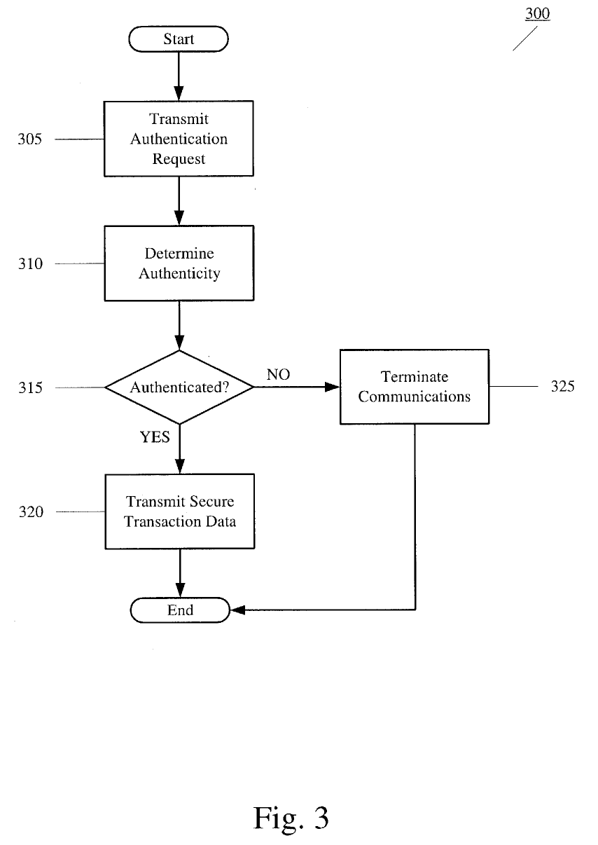

FIG. 3 shows a second method 300 for receiving data related to a secure transaction according to an exemplary embodiment of the present invention. The second method 300 will be described in relation to the second exemplary embodiment of the present invention where the DAD 115 is a transceiver and the data card 150 is an ICC. The second method 300 will be described with reference to the system 100 of FIG. 1.

In step 305, the data card 150 may transmit a query to the MU 100 requesting a transmission of authenticity. As discussed above, the data card 150 may be configured to prevent a transmission of confidential information until a reply to the request is received. Also as discussed above, the MU 100 may determine authenticity in a substantially similar manner as the first exemplary embodiment of the present invention.

In step 310, the data card 150 may determine the authenticity of the MU 100. In a first example, the data card 150 may receive a reply to the request for authenticity. The reply may indicate whether the MU 100 is an authenticated payment device or not an authenticated payment device. In a second example, the data card 150 may determine that the MU 100 is not an authenticated payment device if a response is not received within a predetermined amount of time.

If step 315 determines that the MU 100 is an authenticated payment device, the method 300 continues to step 320 where the secure transaction data is transmitted to the MU 100 to verify the buyer's credentials. However, if step 315 determines that the MU 100 is not an authenticated payment device, the method 300 continues to step 325 where the data card 150 terminates any communications with the DAD 115.

The exemplary embodiments of the present invention provide a bi-directional verification for a secure transaction. The first verification relates to a buyer's credentials. The data card of the buyer may transmit confidential information such as an account number, a PIN, etc. The second verification may relate to an integrity of the payment receiving device that receives the confidential information. That is, the buyer may also be provided a guarantee that the confidential information to be provided will not be intercepted, for example, by a rogue program. Thus, the retail facility may guarantee that the products to be purchased will be compensated as well as the buyer purchasing the products be guaranteed that the confidential information will be used for the specific purpose of purchasing without fear that such information will be received by an unauthorized party.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A system, comprising:
a data card storing confidential data related to a secure transaction; and
a payment receiving device receiving the confidential data,
wherein a first credibility relating to the payment receiving device is verified, and
wherein, upon the first credibility being verified, a second credibility relating to the data card is verified.

2. The system of claim 1, wherein the second credibility is a buyer's credentials.

3. The system of claim 1, wherein the first credibility is a determination of whether the payment receiving device is authenticated to receive the confidential data.

4. The system of claim 1, wherein the data card is one of a credit card, a debit card, an integrated circuit card, and a near field communications device.

5. The system of claim 4, wherein the payment receiving device includes a data acquisition device.

6. The system of claim 5, wherein the data acquisition device is one of a magnetic stripe reader and a transceiver.

7. The system of claim 6, wherein the magnetic stripe reader is deactivated until the second credibility is verified.

8. The system of claim 6, wherein the integrated circuit card terminates a communication with the payment receiving device when the first credibility is not verified.

9. The system of claim 1, wherein the first credibility is verified upon receiving a key from an authorized source.

10. The system of claim 1, wherein an alert is provided to indicate whether the first credibility has been verified.

11. A method, comprising:
determining a first credibility of a payment receiving device; and
receiving, by the payment receiving device, confidential data stored in a data card to verify a second credibility only upon the first credibility being verified, the second credibility relating to the data card.

12. The method of claim 11, wherein the first credibility is a determination of whether the payment receiving device is authenticated to receive the confidential data.

13. The method of claim 11, wherein the first credibility is a buyer's credentials.

14. The method of claim 11, wherein the data card is one of a credit card, a debit card, an integrated circuit card, and a near field communications device.

15. The method of claim 14, wherein the payment receiving device includes a data acquisition device.

16. The method of claim 15, wherein the data acquisition device is one of a magnetic stripe reader and a transceiver.

17. The method of claim 16, further comprising:
deactivating the magnetic stripe reader until the first credibility is verified.

18. The method of claim 16, further comprising:
terminating a communication between the integrated circuit card and the payment receiving device when the second credibility is not verified.

19. The method of claim 11, wherein the second credibility is verified upon receiving a key from an authorized source.

20. A system, comprising:
a storage means for storing confidential data related to a secure transaction; and
a processing means for receiving the confidential data,
wherein a first credibility relating to the processing means is verified, and
wherein, upon the first credibility being verified, a second credibility relating to the storage means is verified.
